(19) United States
(12) Patent Application Publication
(10) Pub. No.: US 2026/0188164 A1
(43) Pub. Date: Jul. 2, 2026

(54) DISPLAY DEVICE

(71) Applicant: TCL China Star Optoelectronics Technology Co., Ltd., Shenzhen (CN)

(72) Inventors: Yating WEN, Shenzhen (CN); Xueqi TANG, Shenzhen (CN); Wennuo HUANG, Shenzhen (CN); Yixin XIAO, Shenzhen (CN); Rong SU, Shenzhen (CN); Shijie DENG, Shenzhen (CN); Haihuan ZHU, Shenzhen (CN); Kaihao MAO, Shenzhen (CN); Shuming CHANG, Shenzhen (CN)

(73) Assignee: TCL China Star Optoelectronics Technology Co., Ltd., Shenzhen (CN)

(21) Appl. No.: 19/365,203

(22) Filed: Oct. 22, 2025

(30) Foreign Application Priority Data
Dec. 31, 2024 (CN) 202411998410.X

(51) Int. Cl. G09G 3/20; G09G 3/36

(52) U.S. Cl. CPC G09G 3/2007; G09G 3/3611; G09G 2320/0233; G09G 2320/10

(57) ABSTRACT

A display device is provided by the present disclosure. The display device includes a display panel and a timing controller. The timing controller is configured to: determine coupling effect accumulation data of the coupling effects of one or more data voltages transmitted by one or more data lines adjacent to a first pixel to be compensated during a previous frame preceding a current frame and the current frame on a data voltage of the first pixel in the current frame; determine a grayscale compensation value for the first pixel in the current frame based on the coupling effect accumulation data and a gain coefficient; and compensate an original grayscale value of the first pixel in the current frame based on the grayscale compensation value to obtain a target grayscale value.

### RELATED APPLICATION(S)

This application claims priority of Chinese Patent Application No. 202411998410.X, filed on Dec. 31, 2024, the contents of which are incorporated by reference as if fully set forth herein in their entirety.

### TECHNICAL FIELD

The present disclosure relates to the field of display technologies, particularly to a display device.

### BACKGROUND

Liquid crystal displays (LCDs) make use of optical properties of liquid crystal materials. They achieve image display by applying different electric fields to the liquid crystals, causing them to deflect at specific angles. LCDs are complex electronic products, and there are numerous coupling capacitors between data wirings, electrodes and thin-film transistors in the liquid crystal display panel. These coupling capacitors may lead to various display issues, such as uneven brightness in the displayed image, also known as the Mura phenomenon.

### SUMMARY

Embodiments of the present disclosure provide a display device to improve the uneven brightness issue caused by the coupling capacitors during the display of the display panel, addressing at least part of the problem mentioned above.

In order to solve the problem mentioned above, an embodiment of the present disclosure provides a display device. The display device includes a display panel and a timing controller. The display panel includes a plurality of data lines and a plurality of pixel columns. Each of the pixel columns is disposed between adjacent ones of the data lines, and includes at least two pixels. The timing controller is connected to the display panel, and is configured to: determine coupling effect accumulation data of coupling effects of one or more data voltages transmitted by one or more of the data lines adjacent to a first pixel to be compensated among the pixels in a current frame during a previous frame preceding the current frame and the current frame on a data voltage of the first pixel in the current frame; determine a grayscale compensation value for the first pixel in the current frame based on the coupling effect accumulation data and a gain coefficient; and compensate an original grayscale value of the first pixel in the current frame based on the grayscale compensation value to obtain a target grayscale value.

In the display devices of the embodiments of the present disclosure, the coupling effect accumulation data of the coupling effects of the one or more data voltages transmitted by the one or more of the data lines adjacent to the first pixel to be compensated during the previous frame and the current frame on the data voltage of the first pixel in the current frame is determined. Then, the grayscale compensation value is determined for the first pixel in the current frame based on the coupling effect accumulation data and the gain coefficient. The original grayscale value of the first pixel is compensated in the current frame based on the grayscale compensation value. In this way, a deviation of the data voltage of the first pixel caused by the effect of capacitive coupling of data lines adjacent to the first pixel during adjacent frames is reduced, and the uneven brightness issue in the displayed image caused by the capacitive coupling during the display of the display panel is improved.

### BRIEF DESCRIPTION OF THE DRAWINGS

FIG. 1 is a schematic view of a structure of a display device according to an embodiment of the present disclosure.

FIG. 2 is a schematic view of a connection relationship between data lines and pixels according to an embodiment of the present disclosure.

FIG. 3 is another schematic view of a connection relationship between data lines and pixels according to an embodiment of the present disclosure.

FIG. 4 is a flowchart diagram of determining a target grayscale value of a first pixel to be compensated by a timing controller according to an embodiment of the present disclosure.

The reference numerals are as follows:
display device 100;
display panel 11;
data line 111, first right-side data line 111A, first left-side data line 111B;
scan line 112;
pixel repeating unit 113A; pixel 113; first subpixel 1131; second subpixel 1132; third subpixel 1133;
timing controller 12; gate driver 13; data driver 14;
first direction X; second direction Y.

### DETAILED DESCRIPTION

The technical solutions in the embodiments of the present disclosure are clearly and completely described below in conjunction with the drawings in the embodiments of the present disclosure. Apparently, the embodiments described are merely part of the embodiments of the present disclosure, rather than all the embodiments. Based on the embodiments in the present disclosure, all other embodiments obtained by a person having ordinary skill in the art without creative efforts should be deemed as falling within the scope of the present disclosure.

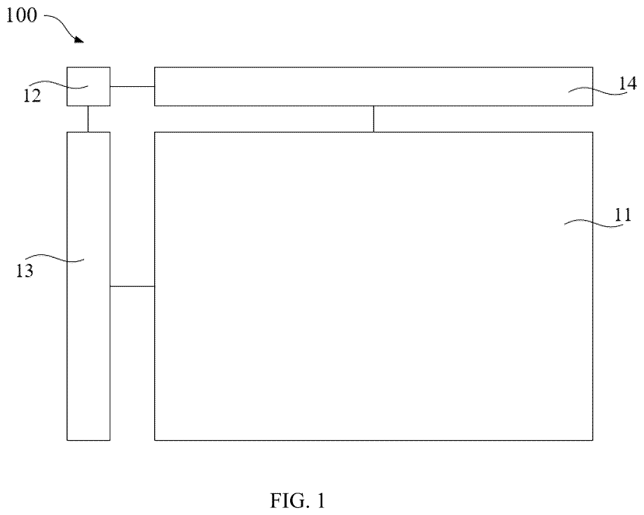

Referring to FIG. 1, the display device 100 includes a display panel 11, a timing controller 12, a gate driver 13, and a data driver 14.

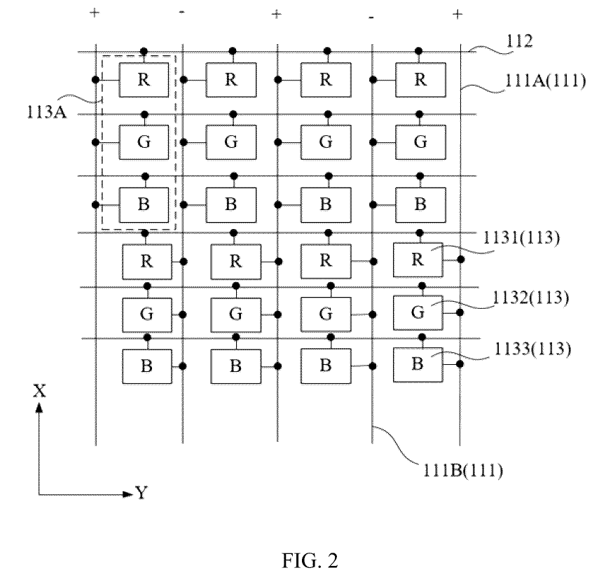

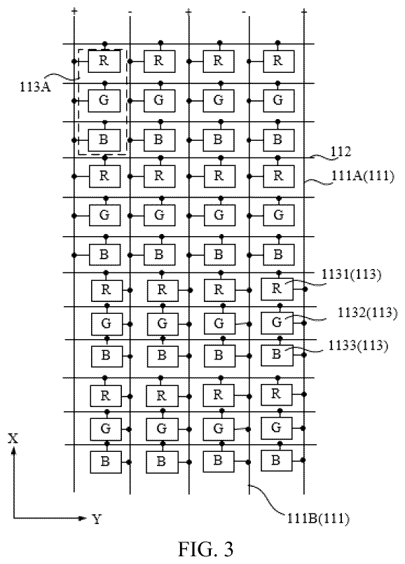

Referring to FIGS. 2 and 3, the display panel 11 includes a plurality of data lines 111, a plurality of scan lines 112, and a plurality of pixels 113 arranged in an array. The plurality of data lines 111 intersect with the plurality of scan lines 112 in an insulated manner.

In some embodiments, the pixel 113 may include an inactive light-emitting device such as an LCD device. In other embodiments, the pixel 113 may include an active light-emitting device such as an organic light-emitting diode or an inorganic light-emitting diode. For example, the pixel 113 may include a pixel electrode and liquid crystals of the LCD device. At this point, the display panel 11 is an LCD panel.

In some embodiments, in a case that the display panel 11 is the LCD panel, data voltages of opposite polarities, namely a first polarity and a second polarity opposite to the first polarity, are output by adjacent ones of the data lines 111, respectively, so as to improve the issue of liquid crystal polarization. The first polarity may be one of a positive polarity and a negative polarity, and the second polarity may be the other of the positive polarity and the negative polarity. For example, the first polarity is represented by “+”, and the second polarity is represented by “−”.

It should be noted that the display panel 11 further includes a common electrode (not shown) in the case that the display panel 11 is the LCD panel. In a case that a data voltage output by the data line 111 to the pixel electrode is greater than a common voltage output by the common electrode, the data voltage output by the data line 111 has the positive polarity. On the contrary, in a case that a data voltage output by the data line 111 to the pixel electrode is less than a common voltage output by the common electrode, the data voltage output by the data line 111 has the negative polarity.

The gate driver 13 is connected to the plurality of scan lines 112 to output scan signals to the plurality of scan lines 112, respectively. The scan signals includes enable scan signals and disable scan signals.

The data driver 14 is connected to the plurality of data lines 111 to output data voltages to the plurality of data lines 111, respectively.

Along a first direction X, the plurality of pixels 113 constitute a plurality of pixel rows, each pixel row including at least two pixels 113 arranged along a second direction Y. The at least two pixels 113 of a pixel row are connected to one scan line 112. Along a second direction Y, the plurality of pixels 113 constitute a plurality of pixel columns, each pixel column including at least two pixels 113 arranged along the first direction X. Each pixel 113 in a pixel column is connected to one data line 111. In some embodiments, the at least two pixels 113 in a pixel column are connected to two data lines 111, respectively.

In a case that the gate driver 13 outputs the enable scan signal to a scan line 112, the scan line 112 is selected, and the data signal output by the data line 111 is output to at least two pixels 113 in the pixel row connected to the scan line 112 that is selected.

In some embodiments, the first direction X intersects with the second direction Y. For example, the first direction X may be perpendicular to the second direction Y.

In some embodiments, referring to FIGS. 2 and 3, the plurality of pixel rows includes a plurality of pixel row groups arranged along the first direction X. The pixel row group includes a first pixel row, a second pixel row, and a third pixel row arranged sequentially along a first direction X. The first pixel row includes at least two first subpixels 1131 arranged along the second direction Y. The second pixel row includes at least two second subpixels 1132 arranged along the second direction Y. The third pixel row includes at least two third subpixels 1133 arranged along the second direction Y. The first subpixel 1131, the second subpixel 1132, and the third subpixel 1133 are different from each other, and they are, for example, a red subpixel, a green subpixel, and a blue subpixel, respectively. The first subpixel 1131, the second subpixel 1132, and the third subpixel 1133 located in one pixel column and one pixel row group constitute a pixel repeating unit 113A.

In some embodiments, referring to FIG. 2, two adjacent ones of the pixel repeating units 113A along the first direction X are connected to two adjacent ones of the data lines 111, respectively. Two adjacent ones of the pixel repeating units 113A along the second direction Y are connected to two adjacent ones of the data lines 111, respectively. The two adjacent ones of the data lines 111 transmit data voltages of the first polarity and the second polarity, respectively.

In some embodiments, referring to FIG. 3, each pixel column includes a plurality of pixel repeating unit pairs, each pixel repeating unit pair including two adjacent pixel repeating units 113A. Two adjacent pixel repeating unit pairs along the first direction X are connected to two adjacent ones of the data lines 111, respectively. Two adjacent pixel repeating unit pairs along the second direction Y are connected to two adjacent ones of the data lines 111, respectively. The two adjacent ones of the data lines 111 transmit data voltages of the first polarity and the second polarity, respectively.

For the design shown in FIGS. 2 and 3, one data line 111 may output corresponding data voltages to the first subpixel 1131 to the third subpixel 1133 of one pixel repeating unit 113A, reducing the number of the data lines 111 and, in turn, the total number of channels of the data driver 14.

The timing controller 12 is connected to the gate driver 13 and the data driver 14, so as to control the gate driver 13 to output scan signals to the scan lines 112 and the data driver 14 to output data voltages to the data lines 111. The timing controller 12 is also connected to the display panel 11.

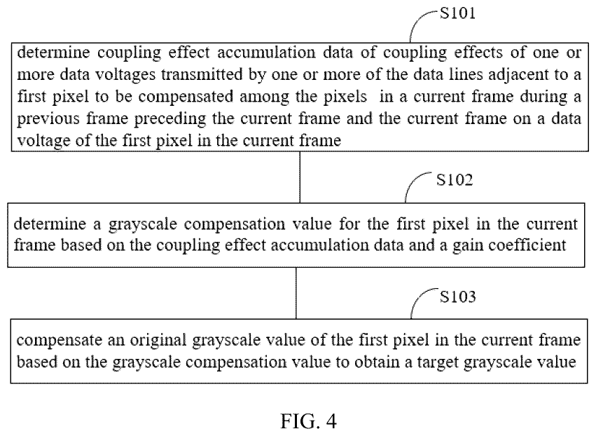

In some embodiments, referring to FIG. 4, the timing controller 12 is configured to: determine coupling effect accumulation data of coupling effects of one or more data voltages transmitted by one or more of the data lines 111 adjacent to a first pixel to be compensated among the pixels 113 in a current frame during a previous frame preceding the current frame and the current frame on a data voltage of the first pixel in the current frame (S101); determine a grayscale compensation value for the first pixel in the current frame based on the coupling effect accumulation data and a gain coefficient (S102); and compensate an original grayscale value of the first pixel in the current frame based on the grayscale compensation value to obtain a target grayscale value (S103). In this way, the grayscale compensation value may reduce a deviation of the data voltage of the first pixel caused by the effect of capacitive coupling of data lines adjacent to the first pixel during adjacent frames, thereby improving the uneven brightness issue in the displayed image caused by the capacitive coupling during the display of the display panel 11.

In some embodiments, the determining of the coupling effect accumulation data may include the following:
determining first coupling effect accumulation data of the coupling effects of the data voltages transmitted by one or more left-side ones of the data lines adjacent to the first pixel during the previous frame and the current frame on the data voltage of the first pixel in the current frame;
determining second coupling effect accumulation data of the coupling effects of the data voltages transmitted by one or more right-side ones of the data lines adjacent to the first pixel during the previous frame and the current frame on the data voltage of the first pixel in the current frame, the first pixel being disposed between the one or more ones left-side ones of the data lines and the one or more right-side ones of the data lines;
obtaining aggregated coupling effect accumulation data based on the first coupling effect accumulation data and the second coupling effect accumulation data; and
obtaining the coupling effect accumulation data based on normalization benchmark data, average benchmark data, and the aggregated coupling effect accumulation data.

In some embodiments of the present disclosure, the first coupling effect accumulation data and the second coupling effect accumulation data are obtained, respectively, based on aggregated coupling effect data of the data voltages output by the one or more data lines 111 on the left-side of the first pixel and the one or more data lines 111 on the right-side of the first pixel during two adjacent frames, thereby taking into account an accumulation coupling capacitance suffered by the data voltage of the first pixel in the current frame due to positional relationship and time. Further, the normalization benchmark data balances the contribution of the first coupling effect accumulation data and the second coupling effect accumulation data to the aggregated coupling effect accumulation data. The average benchmark data equalizes the aggregated coupling effect accumulation data. Therefore, the grayscale compensation value, which is obtained based on the coupling effect accumulation data and the gain coefficient, may better compensate for the offset of the data voltage of the first pixel caused by adjacent data lines 111 during the cumulative two frames, thereby improving the uneven brightness issue of the display screen.

In some embodiments, the determining of the first coupling effect accumulation data may include the following:
determining first left-side coupling capacitance accumulation data of the coupling effects of the data voltages transmitted by a first left-side data line adjacent to the first pixel during the previous frame and the current frame on the data voltage of the first pixel in the current frame; and
obtaining the first coupling effect accumulation data based on the first left-side coupling capacitance accumulation data and a first left-side coupling effect coefficient of the first left-side data line corresponding to the first pixel.

In some embodiments of the present disclosure, since the first left-side data line is the left-side one of the data lines closest to the first pixel, it has a greater effect on the data voltage of the first pixel in the current frame. Therefore, the coupling effect of the first left-side data line on the first pixel is the main effect of the left-side ones of the data lines on the first pixel.

In other embodiments, the determining of the first coupling effect accumulation data may include the following:
determining first left-side coupling capacitance accumulation data of the coupling effects of the data voltages transmitted by a first left-side data line adjacent to the first pixel during the previous frame and the current frame on the data voltage of the first pixel in the current frame;
determining second left-side coupling capacitance accumulation data of the coupling effects of the data voltages transmitted by a second left-side data line adjacent to the first pixel during the previous frame and the current frame on the data voltage of the first pixel in the current frame, the first left-side data line being disposed between the second left-side data line and the first pixel;
obtaining first left-side coupling effect accumulation data based on the first left-side coupling capacitance accumulation data and a first left-side coupling effect coefficient of the first left-side data line corresponding to the first pixel;
obtaining second left-side coupling effect accumulation data based on the second left-side coupling capacitance accumulation data and a second left-side coupling effect coefficient of the second left-side data line corresponding to the first pixel;
obtaining the first coupling effect accumulation data based on the first left-side coupling effect accumulation data and the second left-side coupling effect accumulation data.

In some embodiments of the present disclosure, since the first left-side data line and the second left-side data line are two left-side ones of the data lines closest to the first pixel, they have a greater effect on the data voltage of the first pixel in the current frame. Therefore, the coupling effects of the first left-side data line and the second left-side data line that are on the left side on the first pixel may represent overall coupling effects of the left-side ones of the data lines on the first pixel.

In some embodiments, the determining of the first left-side coupling capacitance accumulation data may include the following:
determining a sum of data voltages output by the first left-side data line during the previous frame to obtain a first data voltage sum;
determining a sum of data voltages output by the first left-side data line during the current frame when data voltages of a row where the first pixel is located are output, to obtain a second data voltage sum;
summing the first data voltage sum and the second data voltage sum to obtain the first left-side coupling capacitance accumulation data.

In other embodiments, the obtaining of the first coupling effect accumulation data based on the first left-side coupling capacitance accumulation data and a first left-side coupling effect coefficient of the first left-side data line corresponding to the first pixel, may include the following:
obtaining first left-side coupling accumulation deviation data based on a difference between a first preset voltage accumulation data and the first left-side coupling capacitance accumulation data;
the first preset voltage accumulation data being equal to a product of a total number of scanned rows and a first data voltage, the total number of scanned rows being represented by (Vₜₒₜₐₗ+i), the first data voltage being a data voltage of a pixel connected to the first left-side data line in an i-th row, the i-th row being a pixel row where the first pixel is located, Vₜₒₜₐₗ being a total number of scan lines;
obtaining the first coupling effect accumulation data based on a product of the first left-side coupling accumulation deviation data and the first left-side coupling effect coefficient.

In other embodiments, the determining of the second left-side coupling capacitance accumulation data may include the following:
determining a sum of data voltages output by the second left-side data line during the previous frame to obtain a third data voltage sum;
determining a sum of data voltages output by the second left-side data line during the current frame when data voltages of a row where the first pixel is located are output, to obtain a fourth data voltage sum;
summing the third data voltage sum and the fourth data voltage sum to obtain the second left-side coupling capacitance accumulation data.

In other embodiments, the obtaining of the second left-side coupling effect accumulation data based on the second left-side coupling capacitance accumulation data and a second left-side coupling effect coefficient of the second left-side data line corresponding to the first pixel, may include the following:
obtaining second left-side coupling accumulation deviation data based on a difference between a second preset voltage accumulation data and the second left-side coupling capacitance accumulation data; the second preset voltage accumulation data being equal to a product of a total number of scanned rows and a second data voltage, the total number of scanned rows being represented by (Vₜₒₜₐₗ+i), the second data voltage being a data voltage of a pixel connected to the second left-side data line in an i-th row, the i-th row being a pixel row where the first pixel is located, Vₜₒₜₐₗ being a total number of scan lines;
obtaining the second left-side coupling effect accumulation data based on a product of the second left-side coupling accumulation deviation data and the second left-side coupling effect coefficient.

In other embodiments, the obtaining of the first coupling effect accumulation data based on the first left-side coupling effect accumulation data and the second left-side coupling effect accumulation data, may include the following:
summing the first left-side coupling effect accumulation data and the second left-side coupling effect accumulation data to obtain the first coupling effect accumulation data.

In some embodiments, the determining of the second coupling effect accumulation data may include the following:
determining first right-side coupling capacitance accumulation data of the coupling effects of the data voltages transmitted by a first right-side data line adjacent to the first pixel during the previous frame and the current frame on the data voltage of the first pixel in the current frame; and
obtaining the second coupling effect accumulation data based on the first right-side coupling capacitance accumulation data and a first right-side coupling effect coefficient of the first right-side data line corresponding to the first pixel.

In some embodiments of the present disclosure, since the first right-side data line is the right-side one of the data lines closest to the first pixel, it has a greater effect on the data voltage of the first pixel in the current frame. Therefore, the coupling effect of the first right-side data line on the first pixel is the main effect of the right-side ones of the data lines on the first pixel.

In other embodiments, the determining of the second coupling effect accumulation data may include the following:
determining first right-side coupling capacitance accumulation data of the coupling effects of the data voltages transmitted by a first right-side data line adjacent to the first pixel during the previous frame and the current frame on the data voltage of the first pixel in the current frame;
determining second right-side coupling capacitance accumulation data of the coupling effects of the data voltages transmitted by a second right-side data line adjacent to the first pixel during the previous frame and the current frame on the data voltage of the first pixel in the current frame, the first right-side data line being disposed between the second right-side data line and the first pixel;
obtaining first right-side coupling effect accumulation data based on the first right-side coupling capacitance accumulation data and a first right-side coupling effect coefficient of the first right-side data line corresponding to the first pixel;
obtaining second right-side coupling effect accumulation data based on the second right-side coupling capacitance accumulation data and a second right-side coupling effect coefficient of the second right-side data line corresponding to the first pixel;
obtaining the second coupling effect accumulation data based on the first right-side coupling effect accumulation data and the second right-side coupling effect accumulation data.

In some embodiments of the present disclosure, since the first right-side data line and the second right-side data line are two right-side ones of the data lines closest to the first pixel, they have a greater effect on the data voltage of the first pixel in the current frame. Therefore, the coupling effects of the first right-side data line and the second right-side data line that are on the right side on the first pixel may represent overall coupling effects of the right-side ones of the data lines on the first pixel.

In some embodiments, the determining of the first right-side coupling capacitance accumulation data may include the following:
determining a sum of data voltages output by the first right-side data line during the previous frame to obtain a fifth data voltage sum;
determining a sum of data voltages output by the first right-side data line during the current frame when data voltages of a row where the first pixel is located are output, to obtain a sixth data voltage sum;
summing the fifth data voltage sum and the sixth data voltage sum to obtain the first right-side coupling capacitance accumulation data.

In some embodiments, the obtaining of the second coupling effect accumulation data based on the first right-side coupling capacitance accumulation data and a first right-side coupling effect coefficient of the first right-side data line corresponding to the first pixel, may include the following:
obtaining first right-side coupling accumulation deviation data based on a difference between a third preset voltage accumulation data and the first right-side coupling capacitance accumulation data; the third preset voltage accumulation data being equal to a product of a total number of scanned rows and a third data voltage, the total number of scanned rows being represented by (Vₜₒₜₐₗ+i), the third data voltage being a data voltage of a pixel connected to the first right-side data line in an i-th row, the i-th row being a pixel row where the first pixel is located, Vₜₒₜₐₗ being a total number of scan lines;
obtaining the second coupling effect accumulation data based on a product of the first right-side coupling accumulation deviation data and the first right-side coupling effect coefficient.

In other embodiments, the determining of the second right-side coupling capacitance accumulation data may include the following:
determining a sum of data voltages output by the second right-side data line during the previous frame to obtain a seventh data voltage sum;
determining a sum of data voltages output by the second right-side data line during the current frame when data voltages of a row where the first pixel is located are output, to obtain an eighth data voltage sum;
summing the seventh data voltage sum and the eighth data voltage sum to obtain the second right-side coupling capacitance accumulation data.

In other embodiments, the first right-side coupling effect accumulation data is equal to a product of the first right-side coupling accumulation deviation data and the first right-side coupling effect coefficient.

In other embodiments, the second right-side coupling effect accumulation data is equal to a product of the second right-side coupling accumulation deviation data and the second right-side coupling effect coefficient. The second right-side coupling accumulation deviation data is equal to a difference between a fourth preset voltage accumulation data and the second right-side coupling capacitance accumulation data. The fourth preset voltage accumulation data is equal to a product of a total number of scanned rows and a fourth data voltage. The fourth data voltage is a data voltage of a pixel connected to the second right-side data line in an i-th row. The total number of scanned rows is represented by (Vₜₒₜₐₗ+i), and Vₜₒₜₐₗ is the total number of scan lines.

In other embodiments, the second coupling effect accumulation data is the sum of the first right-side coupling effect accumulation data and the second right-side coupling effect accumulation data.

It should be noted that the first left-side coupling effect coefficient, the second left-side coupling effect coefficient, the first right-side coupling effect coefficient, and the second right-side coupling effect coefficient each represent the relative difference of the coupling capacitance affected by the data voltages output by corresponding ones of the data lines that is, they take into account the degree of influence of different data lines on the aggregated coupling effect data. For example, if the first left-side coupling effect coefficient is greater than the first right-side coupling effect coefficient, it indicates that the data voltage output by the first left-side data line has a greater impact on the coupling capacitance experienced by the first pixel. Conversely, if the first right-side coupling effect coefficient is greater than the first left-side coupling effect coefficient, it indicates that the data voltage output by the first right-side data line has a greater impact on the coupling capacitance experienced by the first pixel.

In an exemplary embodiment, in a case that the first coupling effect accumulation data is determined based on the first left-side coupling capacitance accumulation data and the first left-side coupling effect coefficient, and the second coupling effect accumulation data is determined based on the first right-side coupling capacitance accumulation data and the first right-side coupling effect coefficient, the sum of the first left-side coupling effect coefficient and the first right-side coupling effect coefficient is equal to 256. Values of the first left-side coupling effect coefficient and the first right-side coupling effect coefficient range from 0 to 256. In a case that the first left-side coupling effect coefficient and the first right-side coupling effect coefficient are both equal to 128, it indicates that the first left-side coupling capacitance accumulation data and the first right-side coupling capacitance accumulation data have equal impacts on the coupling capacitance experienced by the first pixel. If the first left-side coupling effect coefficient is greater than 128, it indicates that the data voltages output by the first left-side data line has a greater impact on the coupling capacitance experienced by the first pixel 113. Conversely, if the first right-side coupling effect coefficient is greater than 128, it indicates that the data voltage output by the first right-side data line has a greater impact on the coupling capacitance experienced by the first pixel.

In another exemplary embodiment, in a case that the first coupling effect accumulation data is equal to the sum of the first left-side coupling effect accumulation data and the second left-side coupling effect accumulation data, and the second coupling effect accumulation data is equal to the sum of the first right-side coupling effect accumulation data and the second right-side coupling effect accumulation data, values of the first left-side coupling effect coefficient, the second left-side coupling effect coefficient, the first right-side coupling effect coefficient, and the second right-side coupling effect coefficient range from 0 to 256. The sum of the first left-side coupling effect coefficient, the second left-side coupling effect coefficient, the first right-side coupling effect coefficient, and the second right-side coupling effect coefficient is equal to 256.

In some embodiments, the obtaining of the coupling effect accumulation data may include the following: dividing the aggregated coupling effect accumulation data by the normalization benchmark data and the average benchmark data to obtain the coupling effect accumulation data. As such, the aggregated coupling effect accumulation data is normalized and averaged.

In some embodiments, in the case that the first coupling effect accumulation data is determined based on the first left-side coupling capacitance accumulation data and the first left-side coupling effect coefficient, and the second coupling effect accumulation data is determined based on the first right-side coupling capacitance accumulation data and the first right-side coupling effect coefficient, the normalization benchmark data is equal to a sum of the first left-side coupling effect coefficient and the first right-side coupling effect coefficient.

In some embodiments, in the case that the first coupling effect accumulation data is equal to the sum of the first left-side coupling effect accumulation data and the second left-side coupling effect accumulation data, and the second coupling effect accumulation data is equal to the sum of the first right-side coupling effect accumulation data and the second right-side coupling effect accumulation data, the normalization benchmark data is equal to a sum of the first left-side coupling effect coefficient, the second left-side coupling effect coefficient, the first right-side coupling effect coefficient, and the second right-side coupling effect coefficient.

In some embodiments, the average benchmark data is equal to a total number of scan lines 12 of the display panel 11, but is not limited thereto.

In some embodiments, the compensating of an original grayscale value of the first pixel in the current frame based on the grayscale compensation value to obtain a target grayscale value, may include the following:

compensating a first original grayscale value of a first target pixel connected to a data line 111 transmitting a data voltage with a first polarity in the current frame based on a first grayscale compensation value, to obtain a first target grayscale value; the first target grayscale value being greater than the first original grayscale value; and

compensating a second original grayscale value of a second target pixel connected to a data line 111 transmitting a data voltage with a second polarity in the current frame based on a second grayscale compensation value, to obtain a second target grayscale value, the second target grayscale value being less than the second original grayscale value, and the second polarity being opposite to the first polarity.

In some embodiments of the present disclosure, the first target pixel and the second target pixel connected to two data lines 111 that output data voltages of different polarities, respectively, are reversely compensated, so as to perform reverse compensation on brighter and darker pixels 113, thereby improving uneven brightness issue of the display panel 11. In particular, in a case that the display panel 11 adopts the driving architecture shown in FIGS. 2 and 3, the horizontal stripe issue caused by the uneven brightness of the display panel 11 may be improved.

In some embodiments, the timing controller 12 is further configured to determine the first target pixel and the second target pixel according to the polarity of the data voltages transmitted by the data line 111 to which each of the plurality of pixels 113 in the current frame is connected and the connection relationship between the pixel 113 and the data line 111 with respect to the pixel columns.

In some embodiments, the determining of the grayscale compensation value for the first pixel in the current frame based on the coupling effect accumulation data and a gain coefficient may include the following: determining a product of the coupling effect accumulation data and the gain coefficient as the grayscale compensation value of the first pixel in the current frame. In this way, the compensation effect of the grayscale compensation value on the first pixel 113 is improved.

In some embodiments, the timing controller 12 is further configured to determine original grayscale data of each of the plurality of pixels 113 in the previous frame as the target grayscale data of the pixel 113 in the previous frame. In this way, the plurality of pixels 113 of the previous frame achieve the image display of the previous frame based on the original grayscale data. Therefore, the display process of two adjacent frames is taken as a compensation cycle, the original grayscale data of the pixel 113 in the previous frame is not compensated, but the original grayscale data of the first pixel 113 in the current frame is compensated.

The timing controller 12 further includes a memory (not shown in the figures). The memory stores the coupling effect coefficients and the gain coefficient(s) of the first pixel. In some embodiments, the coupling effect coefficients may include the first left-side coupling effect coefficient and the first right-side coupling effect coefficient. In other embodiments, the coupling effect coefficients may include the first left-side coupling effect coefficient, the second left-side coupling effect coefficient, the first right-side coupling effect coefficient, and the second right-side coupling effect coefficient.

The coupling effect coefficients and the gain coefficient(s) of the first pixel 113 are obtained by debugging pure color images with uneven brightness and darkness to make the horizontal strip phenomenon less severe.

Specifically, in a case that the pure color image is displayed on the display panel 11, a plurality of regions are divided according to the brightness and darkness of the pure color image, and a target region is determined from the plurality of regions. Then, an initial first left-side coupling effect coefficient and an initial gain coefficient are set for the target region. The first left-side coupling effect coefficient and the gain coefficient for the target region may be obtained by adjusting the initial first left-side coupling effect coefficient and the initial gain coefficient until the uneven brightness and darkness of the target region can be made less severe. The target region may be a central region of the display panel 11.

After adjusting the horizontal stripes in the target region, switch back and forth between the states before and after the adjustment. The severity of the horizontal stripes in other regions of the display panel is observed. If the brightness unevenness issue such as the horizontal stripes in other regions is also less severe, it indicates that the first left-side coupling effect coefficient of the target region may be used for those regions. If the brightness unevenness issue such as the horizontal stripes in other regions is less severe than before the adjustment but still visible, it suggests that the compensation is insufficient and needs to be continued based on the first left-side coupling effect coefficient of the target region. For example, if the first left-side coupling effect coefficient is obtained by adding 30 to 128, it can be further increased by 20 on the basis of 158. If the brightness unevenness issue such as the horizontal stripes in other regions is more severe than before the adjustment, which means over-compensation has occurred, values need to be added or subtracted in the opposite direction of the original compensation.

Hereinafter, a calculation process of the grayscale compensation value Gᵢⱼ for the first pixel to which an i-th row scan line and a j-th data line are connected in the current frame is described.

First, grayscale data of the previous frame image is converted into the voltage data of the image through the grayscale-voltage correspondence relationship of the display panel. Then, voltage data of two data lines 111 adjacent to the first pixel connected to the i-th row scan line 112 and the j-th data line 111 are accumulated. The calculation formula is as follows:

$${S}_{j ( j = 2 : 2 : ImgW - 2 , Frame = 1 )} = {\sum }_{i = 1 : 2 : {V}_{total} - 1} {V}_{( ij , Frame = 1 )} ( {G}_{R} ) + {V}_{( ij , Frame = 1 )} ( {G}_{G} ) + {V}_{( ij , Frame = 1 )} ( {G}_{B} ) + {\sum }_{i = 2 : 2 : {V}_{total}} {V}_{( i ( j - 1 ) , Frame = 1 )} ( {G}_{R} ) + {V}_{( i ( j - 1 ) , Frame = 1 )} ( {G}_{G} ) + {V}_{( i ( j - 1 ) , Frame = 1 )} ( {G}_{B} )$$

$${S}_{j ( j = 3 : 2 : ImgW - 1 , Frame = 1 )} = {\sum }_{i = 1 : 2 : {V}_{total} - 1} {V}_{( ij , Frame = 1 )} ( {G}_{R} ) + {V}_{( ij , Frame = 1 )} ( {G}_{G} ) + {V}_{( ij , Frame = 1 )} ( {G}_{B} ) + {\sum }_{i = 2 : 2 : {V}_{total}} {V}_{( i ( j - 1 ) , Frame = 1 )} ( {G}_{R} ) + {V}_{( i ( j - 1 ) , Frame = 1 )} ( {G}_{G} ) + {V}_{( i ( j - 1 ) , Frame = 1 )} ( {G}_{B} )$$

where S_{j(j=2:2:ImgW-2,Frame=1)} is a voltage data sum of the data voltages transmitted by the first left-side data line 111B adjacent to the first pixel in the previous frame, and S_{j(j=3:2:ImgW-1,Frame=1)} is a voltage data sum of the data voltages transmitted by the first right-side data line 111A adjacent to the first pixel in the previous frame. The polarities of the data voltages transmitted by the first left-side data line 111B are opposite to the polarities of the data voltages transmitted by the first right-side data line 111A. G_{R}, G_{G}, and G_{B} are grayscale data of a red pixel, a green pixel, and a blue pixels in the previous frame, respectively. V_{(ij, Frame=1)}(G_{R}) is equal to the data voltage corresponding to the grayscale data of the red pixel in the previous frame. V_{(ij, Frame=1)}(G_{G}), V_{(ij, Frame=1)}(G_{B}), and the like can be derived by analogy, and are not described herein. Vₜₒₜₐₗ is equal to the total number of scan lines 112.

Then, grayscale data of the current frame is converted into the voltage data of the image through the grayscale-voltage correspondence relationship of the panel, and the data voltages output in the current frame by two data lines 111 adjacent to the first pixel 113 connected to the i-th row scan line and the j-th data line are accumulated, and the calculation formula is as follows:

$${S}_{ij} = {S}_{j ( j = 2 : 2 : ImgW - 2 , Frame = 1 )} + {\sum }_{k = 1 : 2 : i} {V}_{( kj , Frame = 2 )} ( {G}_{R} ) + {V}_{( kj , Frame = 2 )} ( {G}_{G} ) + {V}_{( kj , Frame = 2 )} ( {G}_{B} ) + {\sum }_{k = 2 : 2 : i} {V}_{( k ( j - 1 ) , Frame = 2 )} ( {G}_{R} ) + {V}_{( k ( j - 1 ) , Frame = 2 )} ( {G}_{G} ) + {V}_{( k ( j - 1 ) , Frame = 2 )} ( {G}_{B} )$$

$${S}_{i , j + 1} = {S}_{j ( j = 3 : 2 : ImgW - 1 , Frame = 1 )} + {\sum }_{k = 1 : 2 : i} {V}_{( kj , Frame = 2 )} ( {G}_{R} ) + {V}_{( kj , Frame = 2 )} ( {G}_{G} ) + {V}_{( kj , Frame = 2 )} ( {G}_{B} ) + {\sum }_{k = 2 : 2 : i} {V}_{( k ( j - 1 ) , Frame = 2 )} ( {G}_{R} ) + {V}_{( k ( j - 1 ) , Frame = 2 )} ( {G}_{G} ) + {V}_{( k ( j - 1 ) , Frame = 2 )} ( {G}_{B} )$$

Sᵢⱼ is equal to the sum of the sum of voltage data output in the current frame when the data voltage corresponding to the i-th row pixel is output by the first left-side data line and S_{j(j=2:2:ImgW-2,Frame=1)}. S_{i,j+1} is equal to the sum of the sum of voltage data output in the current frame when the data voltage corresponding to the i-th row pixel is output by the first right-side data line and S_{j(j=3:2:ImgW-1,Frame=1)}. V_{(kj, Frame=2)}(G_{R}) is equal to the data voltage corresponding to the grayscale data of the red pixel in the current frame. V_{(kj, Frame=2)}(G_{G}), V_{(kj, Frame=2)}(G_{B}), and the like may be derived by analogy, and is not described herein.

The formula for calculating the grayscale compensation value of the first pixel in the current frame is as follows:

$$Δ {G}_{ij} = ( ( ( {V}_{total} + i ) V ( {G}_{ij} ) - {S}_{ij} ) \times {a}_{ij} + ( ( {V}_{total} + i ) V ( {G}_{i , j + 1} ) - {S}_{i , j + 1} ) \times ( 256 - {a}_{ij} ) ) \times \frac{Gain ( color , {G}_{ij} )}{256 \times {V}_{total}}$$

aᵢⱼ is the first left-side coupling effect coefficient, (256−aᵢⱼ) is the first right-side coupling effect coefficient. Gain(color, Gᵢⱼ) is the gain coefficient. ΔGᵢⱼ is the grayscale compensation value of the first pixel in the current frame. V(Gᵢⱼ) is the data voltage of the pixel to which the first left-side data line 111B is connected in the i-th row of pixels. V(G_{i, j+1}) is the data voltage of the pixel to which the first right-side data line is connected in the i-th row pixel. Vₜₒₜₐₗ is equal to the total number of scan lines 112. i represents the number of row in which the i-th row pixel is located. 256 is the normalization benchmark data.

In the field of display panels, the timing controller 12 is a critical component that governs the driving and data transmission of the display panel. It receives image data and control signals from the main control board and generates signals to drive the gate and source drivers of the display panel, thereby achieving precise image display. In some implementations, the timing controller 12 may be hardware-based, such as using application-specific integrated circuits (ASICs), field-programmable gate arrays (FPGAs), or complex programmable logic devices (CPLDs). These hardware circuits are designed for efficient image data processing and drive signal generation, offering advantages of high performance and stability. In other implementations, the timing controller 12 can be software-based, typically running on general or special-purpose processors, such as driver programs and control algorithms in embedded operating systems (e.g., Linux, Android). These software modules invoke hardware resources to achieve precise display panel control, providing flexibility and expandability. In yet some other implementations, the timing controller 12 may also be implemented in firmware, usually stored in non-volatile memory (e.g., EEPROM, Flash), containing precompiled control logic and algorithms for initializing and controlling the display panel. This approach allows for on-site updates to fix vulnerabilities or enhance performance.

In some examples, the timing controller 12 can be implemented in a combined manner, such as using ASICs or FPGAs as the core processing units along with embedded processors running control software. This combined approach can leverage the efficiency of hardware and the flexibility of software to achieve an optimal balance of performance and cost. Regardless of the implementation method, the timing controller 12 can effectively control the driving and data transmission of the display panel, ensuring stable and high-quality image display. Thus, the various implementation forms of the timing controller 12 can meet different design requirements and production scales, fully reflecting its diversity and practicality in the field of display panel technology.

The descriptions of the above-mentioned embodiments are only used to help understand the technical solutions and core ideas of the present disclosure. Those of ordinary skill in the art should understand that they can still modify the technical solutions described in the foregoing embodiments, or equivalently replace some of the technical features; and these modifications or replacements do not cause the essence of the corresponding technical solutions to deviate from the scope of the technical solutions of the embodiments of the present disclosure.

What is claimed is:

1. A display device, comprising:
a display panel, comprising a plurality of data lines and a plurality of pixel columns, each of the pixel columns being disposed between adjacent ones of the data lines and comprising at least two pixels; and
a timing controller, connected to the display panel, and being configured to:
determine coupling effect accumulation data of coupling effects of one or more data voltages transmitted by one or more data lines adjacent to a first pixel to be compensated among the pixels in a current frame during a previous frame preceding the current frame and the current frame on a data voltage of the first pixel in the current frame;
determine a grayscale compensation value for the first pixel in the current frame based on the coupling effect accumulation data and a gain coefficient; and
compensate an original grayscale value of the first pixel in the current frame based on the grayscale compensation value to obtain a target grayscale value.

2. The display device according to claim 1, wherein the determining of the coupling effect accumulation data comprising the following:
determining first coupling effect accumulation data of the coupling effects of the data voltages transmitted by one or more left-side ones of the data lines adjacent to the first pixel during the previous frame and the current frame on the data voltage of the first pixel in the current frame;
determining second coupling effect accumulation data of the coupling effects of the data voltages transmitted by one or more right-side ones of the data lines adjacent to the first pixel during the previous frame and the current frame on the data voltage of the first pixel in the current frame, the first pixel being disposed between the one or more left-side ones of the data lines and the one or more right-side ones of the data lines;
obtaining aggregated coupling effect accumulation data based on the first coupling effect accumulation data and the second coupling effect accumulation data; and
obtaining the coupling effect accumulation data based on normalization benchmark data, average benchmark data, and the aggregated coupling effect accumulation data.

3. The display device according to claim 2, wherein the determining of the first coupling effect accumulation data comprising the following:
determining first left-side coupling capacitance accumulation data of the coupling effects of the data voltages transmitted by a first left-side data line adjacent to the first pixel during the previous frame and the current frame on the data voltage of the first pixel in the current frame; and
obtaining the first coupling effect accumulation data based on the first left-side coupling capacitance accumulation data and a first left-side coupling effect coefficient of the first left-side data line corresponding to the first pixel.

4. The display device according to claim 3, wherein the obtaining of the first coupling effect accumulation data based on the first left-side coupling capacitance accumulation data and a first left-side coupling effect coefficient of the first left-side data line corresponding to the first pixel comprising the following:
obtaining first left-side coupling accumulation deviation data based on a difference between a first preset voltage accumulation data and the first left-side coupling capacitance accumulation data;
the first preset voltage accumulation data being equal to a product of a total number of scanned rows and a first data voltage, the total number of scanned rows being represented by (Vₜₒₜₐₗ+i), the first data voltage being a data voltage of a pixel connected to the first left-side data line in an i-th row, the i-th row being a pixel row where the first pixel is located, Vₜₒₜₐₗ being a total number of scan lines; and
obtaining the first coupling effect accumulation data based on a product of the first left-side coupling accumulation deviation data and the first left-side coupling effect coefficient.

5. The display device according to claim 2, wherein the determining of the first coupling effect accumulation data comprising the following:
determining first left-side coupling capacitance accumulation data of the coupling effects of the data voltages transmitted by a first left-side data line adjacent to the first pixel during the previous frame and the current frame on the data voltage of the first pixel in the current frame;
determining second left-side coupling capacitance accumulation data of the coupling effects of the data voltages transmitted by a second left-side data line adjacent to the first pixel during the previous frame and the current frame on the data voltage of the first pixel in the current frame, the first left-side data line being disposed between the second left-side data line and the first pixel;
obtaining first left-side coupling effect accumulation data based on the first left-side coupling capacitance accumulation data and a first left-side coupling effect coefficient of the first left-side data line corresponding to the first pixel;
obtaining second left-side coupling effect accumulation data based on the second left-side coupling capacitance accumulation data and a second left-side coupling effect coefficient of the second left-side data line corresponding to the first pixel; and
obtaining the first coupling effect accumulation data based on the first left-side coupling effect accumulation data and the second left-side coupling effect accumulation data.

6. The display device according to claim 5, wherein the determining of the first left-side coupling capacitance accumulation data comprising the following:
determining a sum of data voltages output by the first left-side data line during the previous frame to obtain a first data voltage sum;
determining a sum of data voltages output by the first left-side data line during the current frame when data voltages of a row where the first pixel is located are output, to obtain a second data voltage sum; and
summing the first data voltage sum and the second data voltage sum to obtain the first left-side coupling capacitance accumulation data.

7. The display device according to claim 5, wherein the determining of the second left-side coupling capacitance accumulation data comprising the following:
determining a sum of data voltages output by the second left-side data line during the previous frame to obtain a third data voltage sum;
determining a sum of data voltages output by the second left-side data line during the current frame when data voltages of a row where the first pixel is located are output to obtain a fourth data voltage sum; and
summing the third data voltage sum and the fourth data voltage sum to obtain the second left-side coupling capacitance accumulation data.

8. The display device according to claim 5, wherein the first coupling effect accumulation data is equal to the sum of the first left-side coupling effect accumulation data and the second left-side coupling effect accumulation data.

9. The display device according to claim 2, wherein the determining of the second coupling effect accumulation data comprising the following:
determining first right-side coupling capacitance accumulation data of the coupling effects of the data voltages transmitted by a first right-side data line adjacent to the first pixel during the previous frame and the current frame on the data voltage of the first pixel in the current frame; and
obtaining the second coupling effect accumulation data based on the first right-side coupling capacitance accumulation data and a first right-side coupling effect coefficient of the first right-side data line corresponding to the first pixel.

10. The display device according to claim 9, wherein the obtaining of the second coupling effect accumulation data based on the first right-side coupling capacitance accumulation data and a first right-side coupling effect coefficient of the first right-side data line corresponding to the first pixel comprising the following:
obtaining first right-side coupling accumulation deviation data based on a difference between a third preset voltage accumulation data and the first right-side coupling capacitance accumulation data;
the third preset voltage accumulation data being equal to a product of a total number of scanned rows and a third data voltage, the total number of scanned rows being represented by (Vₜₒₜₐₗ+i), the third data voltage being a data voltage of a pixel connected to the first right-side data line in an i-th row, the i-th row being a pixel row where the first pixel is located, Vₜₒₜₐₗ being a total number of scan lines; and
obtaining the second coupling effect accumulation data based on the product of the first right-side coupling accumulation deviation data and the first right-side coupling effect coefficient.

11. The display device according to claim 2, wherein the determining of the second coupling effect accumulation data comprising the following:
determining first right-side coupling capacitance accumulation data of the coupling effects of the data voltages transmitted by a first right-side data line adjacent to the first pixel during the previous frame and the current frame on the data voltage of the first pixel in the current frame;
determining second right-side coupling capacitance accumulation data of the coupling effects of the data voltages transmitted by a second right-side data line adjacent to the first pixel during the previous frame and the current frame on the data voltage of the first pixel in the current frame, the first right-side data line being disposed between the second right-side data line and the first pixel;
obtaining first right-side coupling effect accumulation data based on the first right-side coupling capacitance accumulation data and a first right-side coupling effect coefficient of the first right-side data line corresponding to the first pixel;
obtaining second right-side coupling effect accumulation data based on the second right-side coupling capacitance accumulation data and a second right-side coupling effect coefficient of the second right-side data line corresponding to the first pixel; and
obtaining the second coupling effect accumulation data based on the first right-side coupling effect accumulation data and the second right-side coupling effect accumulation data.

12. The display device according to claim 11, wherein the determining of the first right-side coupling capacitance accumulation data comprising the following:
determining a sum of data voltages output by the first right-side data line during the previous frame to obtain a fifth data voltage sum;
determining a sum of data voltages output by the first right-side data line during the current frame when data voltages of a row where the first pixel is located are output, to obtain a sixth data voltage sum; and
summing the fifth data voltage sum and the sixth data voltage sum to obtain the first right-side coupling capacitance accumulation data.

13. The display device according to claim 11, wherein the determining of the second right-side coupling capacitance accumulation data comprising the following:
determining a sum of data voltages output by the second right-side data line during the previous frame to obtain a seventh data voltage sum;
determining a sum of data voltages output by the second right-side data line during the current frame when data voltages of a row where the first pixel is located are output, to obtain an eighth data voltage sum; and
summing the seventh data voltage sum and the eighth data voltage sum to obtain the second right-side coupling capacitance accumulation data.

14. The display device according to claim 2, wherein the obtaining of the coupling effect accumulation data comprising the following:
dividing the aggregated coupling effect accumulation data by the normalization benchmark data and the average benchmark data to obtain the coupling effect accumulation data.

15. The display device according to claim 2, wherein the average benchmark data is equal to a total number of scan lines of the display panel.

16. The display device according to claim 1, wherein the compensating of an original grayscale value of the first pixel in the current frame based on the grayscale compensation value to obtain a target grayscale value, comprising:
compensating a first original grayscale value of a first target pixel connected to a data line transmitting a data voltage with a first polarity in the current frame based on a first grayscale compensation value, to obtain a first target grayscale value; the first target grayscale value being greater than the first original grayscale value; and
compensating a second original grayscale value of a second target pixel connected to a data line transmitting a data voltage with a second polarity in the current frame based on a second grayscale compensation value, to obtain a second target grayscale value; the second target grayscale value being less than the second original grayscale value, and the second polarity being opposite to the first polarity.

17. The display device according to claim 1, wherein the timing controller is further configured to determine original grayscale data of each of the plurality of the pixels in the previous frame as target grayscale data of the pixel in the previous frame.

18. The display device according to claim 1, wherein at least two pixels of each of the pixel columns are connected to two of the data lines, respectively.
